(19) United States
(12) Patent Application Publication
(10) Pub. No.: US 2011/0219402 A1
(43) Pub. Date: Sep. 8, 2011

(54) APPARATUS AND METHOD FOR REPLACING A BROADCASTED ADVERTISEMENT BASED ON HEURISTIC INFORMATION

(75) Inventors: Brant L. Candelore, San Diego, CA (US); Frederick J. Zustak, Poway, CA (US)

(73) Assignee: SONY CORPORATION, Tokyo (JP)

(21) Appl. No.: 12/772,779

(22) Filed: May 3, 2010

Related U.S. Application Data
(63) Continuation-in-part of application No. 12/772,544, filed on May 3, 2010.
(60) Provisional application No. 61/311,035, filed on Mar. 5, 2010.

(51) Int. Cl. H04N 7/025

(52) U.S. Cl. 725/34

(57) ABSTRACT

According to one embodiment of the invention, an apparatus comprises a data storage unit and a data processing unit. Coupled to the data storage unit, the data processing unit is adapted to the access heuristic information stored in the data storage unit and transmitting a signal that is used to at least partially control selection of broadcast advertisements being downloaded so that the broadcast advertisements are more suited to the subject matter of interest to the user.

### CROSS-REFERENCE TO RELATED APPLICATIONS

This application is a continuation-in-part application of U.S. patent application Ser. No. 12/772,544, which claims the benefit of priority on U.S. Provisional Patent Application No. 61/311,035 filed Mar. 5, 2010.

### FIELD

The invention is related to the field of content recordation and playback. More specifically, certain embodiments of the invention are directed to the selection and/or playback of advertisements targeted for a recipient using heuristic information.

### BACKGROUND

Currently, television is widely used as a source of both information and entertainment. Cable and satellite systems broadcast tens or even hundreds of channels of programming. Given the large number of programs that are available to a viewer and are broadcast at prescribed times, in some situations, a viewer may be unable to watch all of the programs that he or she wishes to see. Consequently, over the last few decades, a number of electronic devices have been developed to record broadcast television signals.

For instance, video cassette recorders (VCRs) provide viewers with an ability to record incoming audiovisual programs on a magnetic tape and to subsequently view such programs. A timer in the VCR allows the user to record these audiovisual programs at their prescribed broadcasting time. Consequently, the recorded programs are available for playback at the user's convenience.

Thereafter, the basic concept of VCRs has been extended to hard-drive or semiconductor based recording devices that is commonly referred to as Personal Video (or Versatile) Recorders (PVRs). Normally, a PVR is connected to a viewer's television and receives content from the viewer's cable box, satellite receiver, antenna or a communication link coupled thereto. The PVR can control the channel tuned on the television, provide an interactive electronic program guide and record programs on a manual or timer-controlled basis.

The PVR can buffer incoming audiovisual programs so that the viewer can pause a “live” television program or replay a portion of a live television program without missing any subsequent segment of the program, as long as the pause or replay does not exceed the storage capacity of the PVR. Additionally, the PVR can be programmed to regularly record a user's favorite programs. Consequently, the PVR provides greater flexibility in recording and capturing incoming audiovisual signals than is available with a VCR.

Within broadcast television programs, advertisements (e.g. television commercials) are interspersed between segments of the audiovisual program and are broadcast as part of the television signal. These advertisements are an important source of revenue for the broadcaster and are an important source in providing current and potential customers with information related to products and services featured in the advertisement.

However, viewers often consider advertising as a nuisance since they normally want to watch a television program without interruption. One reason is that the advertisements normally are not directed to anything that interests the viewer. Consequently, when a viewer has recorded the program using a PVR, the viewer will tend to fast-forward through the program during advertisements or skip ahead. Usually there is no audio playback during a “fast-forward” or “skip” operation. Hence, while the audio is muted, the playback of images is accelerated to minimize the interruption in viewing the recorded program.

As a result, since “fast-forwarding” and “skip” operations focus the viewing experience on the audiovisual (television) program, they are detrimental to both the advertiser who is trying to reach potential customers and the broadcaster who depends upon advertising for revenue.

### BRIEF DESCRIPTION OF THE DRAWINGS

The present invention is illustrated by way of example, and not by way of limitation, in the figures of the accompanying drawings and in which:

FIG. 1A is a first exemplary embodiment of a system implementing an advertisement control unit within a digital device.

FIG. 1B is a second exemplary embodiment of a system implementing an advertisement control unit within a digital device.

FIG. 1C is a second exemplary embodiment of a system implementing an advertisement control unit within a digital device.

FIG. 2 is an exemplary embodiment of the digital device of FIG. 1C.

FIGS. 3A-3B are exemplary embodiments of an advertisement profile for use in controlling selection, storage and/or playback of advertisements.

FIG. 3C is an exemplary embodiment of a message for transferring the advertisement profile to a content provider remotely located from the digital device.

FIGS. 3D-3E are exemplary embodiments of the content stream format.

FIG. 4A is an exemplary embodiment of a user interface produced by the advertisement control unit of the digital device to commence registration of one or more recipients.

FIG. 4B is an exemplary embodiment of a user interface produced by the advertisement control unit of the digital device to program the preferred advertisements for a first recipient.

FIGS. 5A-5C are exemplary embodiments of the user interfaces produced by the advertisement control unit of the digital device to program the preferred genre for the advertisements.

FIGS. 6A and 6B are exemplary embodiments of user interfaces that allow the recipient to select the particular source upon which the advertisements may be extracted.

FIG. 7 is an exemplary embodiment of the user interface produced by the advertisement control unit of the digital device to preclude certain genre of advertisements for particular recipients.

FIGS. 8A-8C are exemplary embodiments of user interfaces produced by the advertisement control unit of the digital device to provide preference ratings for the advertisements.

FIGS. 9A and 9B are exemplary embodiments of a user interface used to determine the current viewing audience.

FIG. 10 is an exemplary embodiment of a flowchart highlighting the controlled selection, storage and/or playback of advertisements based on heuristic information.

### DETAILED DESCRIPTION

In the following description, for the purposes of explanation, numerous specific details are set forth in order to provide a thorough understanding of the invention. The following description provides exemplary embodiments of the invention, and the accompanying drawings show these various exemplary embodiments for illustrative purposes. However, these exemplary embodiments should not be construed in a limiting sense as they are merely intended to provide examples of the invention rather than to provide an exhaustive list of all possible implementations. In other instances, well-known structures and devices are not shown in block diagram form in order to avoid obscuring the details of the invention.

In the following description, certain terminology is used to describe features of the invention. For instance, the term “digital device” may refer to consumer electronic equipment that is adapted to perform some or all of the following operations on transmissions from a content provider: tune, receive, decrypt, descramble, decode, and playback. Examples of consumer electronic equipment may include, but is not limited or restricted to a television, a set-top box, a personal digital assistant (PDA), a computer, a telephone that is cellular or wireless enabled, a video game console, a portable or stationary music player, a personal video recorder (PVR), or the like. Also, examples of a “content provider” include, but are not limited or restricted to a terrestrial broadcaster, a cable headend or satellite television distribution system, any system providing downloadable content over the Internet or another Internet Protocol (IP) based network such as an Internet Service Provider (ISP), or the like.

In certain situations, the terms “unit” and “logic” are representative of hardware, firmware and/or software configured to perform one or more functions. Examples of “hardware” include, but are not limited or restricted to an integrated circuit such as memory or a processor (e.g., a digital signal processor, microprocessor, application specific integrated circuit, a micro-controller, a type of programmable gate array, etc.). Of course, the hardware simply may be a collection of combinatorial logic.

An example of “software” includes executable code in the form of an application, an applet, a routine or even a series of instructions. The software may be stored in any type of machine readable medium such as a programmable electronic circuit, a semiconductor memory device such as volatile memory (e.g., random access memory, etc.) and/or non-volatile memory (e.g., any type of read-only memory “ROM”, flash memory, etc.), a hard drive disk, a flash drive, a floppy diskette, an optical disk (e.g., compact disk or digital video disc “DVD”), magnetic tape, or the like.

I. Exemplary System/Device Architecture

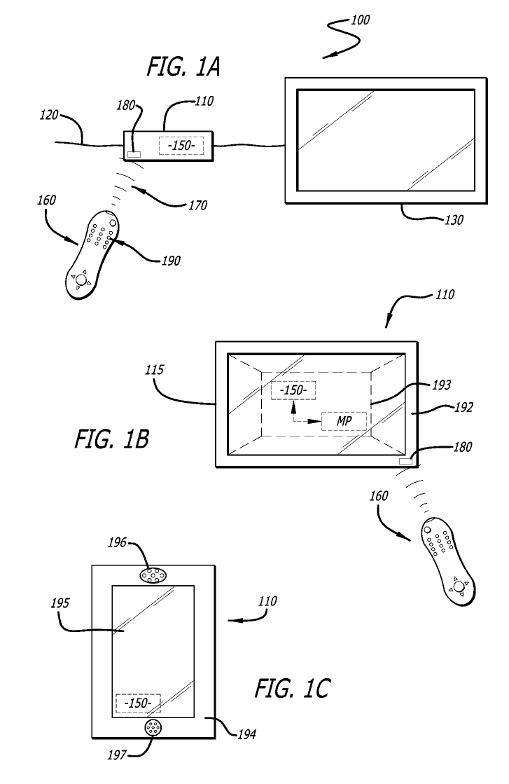

Referring to FIG. 1A, a first exemplary embodiment of a content delivery system 100 implementing an advertisement control unit within a digital device is shown. One purpose of content delivery system 100 is to deliver content from a content provider to a targeted destination.

As shown in FIG. 1A, the targeted designation includes a digital device 110 (e.g., set-top box, PVR, etc.) that receives digital content from the content provider over an input link 120. This digital content includes advertisements (e.g., video and/or audio) interspersed between segments of an audiovisual program. Herein, the advertisements are delivered in the same channel as the audiovisual program, and, as an option, may be delivered within the same data stream. Alternatively, of course, the advertisements may be delivered out-of-band or over a different channel than the channel used to deliver the audiovisual program.

For this system embodiment, digital device 110 is coupled to a second digital device 130 (e.g., television) that is adapted to display the content. Digital device 110 includes an advertisement control unit 150 that utilizes an advertisement profile of the content recipient (e.g., one or more viewers, listeners, etc.) to control the selection, storage and/or playback of advertisements on television 130.

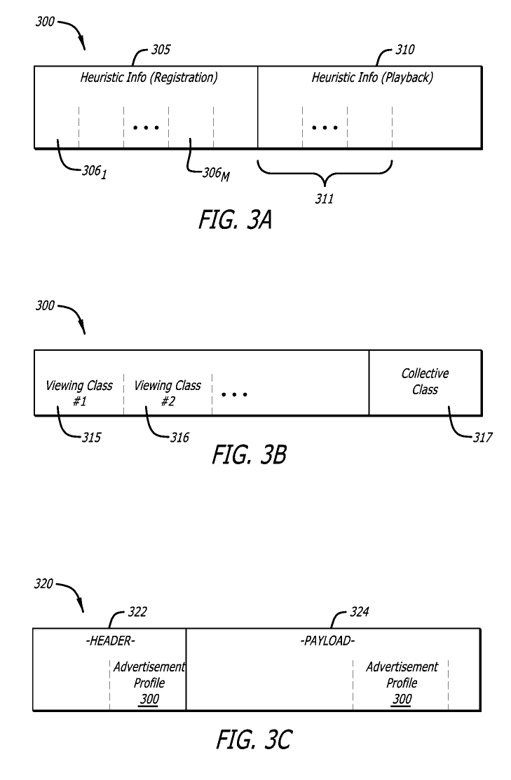

According to this embodiment of the invention, as shown in FIGS. 3A and 3B, advertisement control unit 150 generates an advertisement profile 300, which either includes or is based on heuristic information about the content recipient. Advertisement profile 300 may be used to assist in one or more of the following: (1) selection of advertisements transmitted from the content provider; (2) storage of the advertisements within digital device 110; and (3) playback of the broadcast or stored advertisements.

According to one embodiment, advertisement profile 300 may include heuristic information concerning the current content recipient. In general, “heuristic information” is information that is used to identify which advertisements may be of greater interest to a recipient of the content being played back. This information can be gathered from attributes and genre preferences learned during registration of the content recipient and/or playback behavior (programming choices and actions) exhibited by the content recipient.

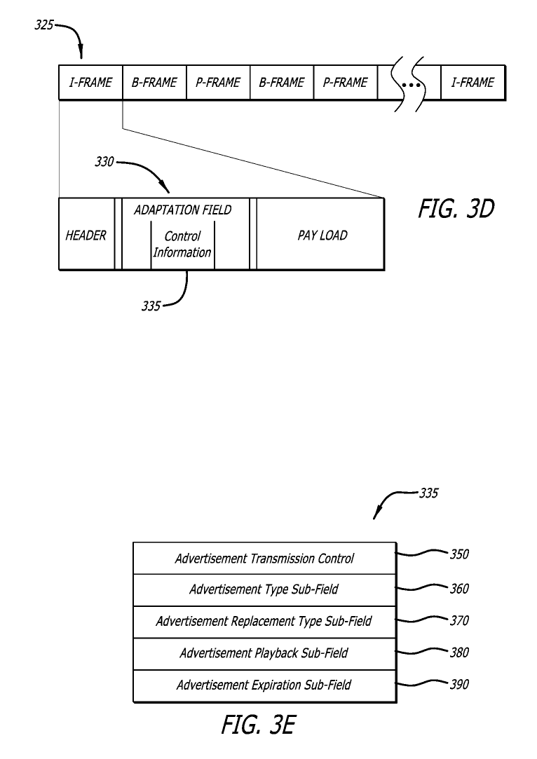

More specifically, as shown in FIG. 3A, a portion of the heuristic information 305 may be acquired during a registration process that is conducted either after an initial power-on of the digital device (and/or an accompanying display device) or after a subsequent power-on operation when a non-registered recipient is identified. Each sub-field 306₁-306_{M} (M≧1) includes data representing an attribute of the recipient. Exemplary illustrations of the registration process are set forth in FIGS. 4A-8C and described below.

Another portion of the heuristic information 310 may be acquired by monitoring programming commands from the recipient in accordance with a passive command monitoring scheme or an active command monitoring scheme. For a passive command monitoring scheme, processing logic within digital device 110 may receive the commands (e.g., list of stored audiovisual programs, record, fast-forward, skip, pause, etc.) from a remote 160 over a communication link 170 and issue appropriate signaling to advertisement control unit 150 as shown in FIG. 1A.

In particular, according to this embodiment of the invention, communication link 170 is a wireless light emitting diode (LED) communication path through which remote 160 sends commands that are formed as light pulses. These light pulses are detected by a LED detector 180 located on digital device 110. Alternatively, link 170 may be radio-frequency (RF) signaling or wireless signaling of other bandwidths where detector 180 constitutes an RF detector.

A particular command from remote 160 may be produced by depressing buttons 190 accessible on an outer top surface of remote 160. Buttons 190 may include a power button, a key of a keypad designating numerals and/or characters, a select button with multidirectional arrows that provide scrolling as needed, PVR control buttons (e.g., record, pause, fast-forward, play, rewind, slow motion, etc.), or the like.

Alternatively, for an active command monitoring scheme, advertisement control unit 150 may monitor for commands being transferred from detector 180 to the processing logic or fetch these commands from local storage. Both of these schemes may be used to form advertisement profile 300 of the recipient.

Regardless of what monitoring scheme is used by digital device 110, these programming commands provide information concerning the playback behavior of the recipient. The information can be conveyed in sub-fields 311 of advertisement profile 300 in order to refine the selection process for advertisements at the content provider as well as to control storage and playback of advertisements at digital device 110. Such information may include, but is not limited or restricted to the following:
(1) the audiovisual programs watched, recorded or blocked (e.g., categorized by subject matter such as genre, topic, educational, etc., political overture, rating, or the like);
(2) the types of advertisements accompanying a recorded audiovisual program that are watched in full;
(3) the types of advertisements accompanying a recorded audiovisual program that are lessened in display time (e.g., skipped, fast-forwarded, etc.);
(4) the types of advertisements that are repeated (reversed for replay) or paused;
(5) the frequency or percentage of advertisements that are lessened in display time compared to all of the advertisements displayed;
(6) the time of viewing; and
(7) the channel(s) normally viewed.

According to another embodiment shown in FIG. 3B, in lieu of transmitting heuristic information, advertisement profile 300 may be configured to include one or more “viewing class” identifiers 315 each being assigned to the content recipient based on the heuristic information. The “viewing class” is a classification of the recipient's anticipated advertisement viewing preferences based upon the heuristic information, namely his or her anticipated advertisement subject matter of interest.

As a result, for this embodiment, advertisements also are assigned to one or more viewing classes. Thus, they represent advertisements having a greater likelihood of being viewed or listened to by a particular content recipient within the same viewing class.

In lieu of or in addition to influencing the selection of the advertisements by the content provider, advertisement control unit 150 may use advertisement profile 300 to control storage and/or playback of advertisements on television 130 (or a display on digital device 110 as illustrated in FIGS. 1B-1C).

It is contemplated that when the content recipient includes multiple viewers, for example, advertisement profile 300 may include a viewing class identifier 315, 316 for each viewer based on the each viewer and/or a class predicated on attributes and/or playback behavior shared by the viewers (“collective class” 317). Alternatively, a weighting may be applied to the heuristic information associated with different viewers in order to select advertisements that may have a greater impact on future purchasing decisions (e.g., greater weight applied to heuristic information concerning viewers within a prescribed range of ages, viewers with higher incomes, etc.).

Referring to FIG. 3C, when used to control the selection of advertisements transmitted from the content provider, advertisement profile 300 is placed within a message 320 that is configured in a format for uploading to the content provider over link 120. For instance, advertisement profile 300 may be placed within a header 322 or payload 324 of message 320.

Referring now to FIG. 1B, a second exemplary embodiment of content delivery system 100 implementing advertisement control unit 150 within digital device 110 is shown. Herein, digital device 110 is a device with a display screen 115. Similar to FIG. 1A, detector 180 is implemented within a casing 192 of digital device 110, namely a flat paneled television. Detector 180 detects signals from remote 160 and transfers those signals (e.g. commands) to a processor (MP) located on a back cabinet 193 of television 130.

Playback behavior of the recipient may be monitored through either a passive command monitoring scheme or an active command monitoring scheme to augment the advertisement profile. Independent on how the advertisement profile is formulated, advertisement control unit 150 is adapted to control the type of advertisements transmitted from the content provider, storage and/or playback of advertisements on digital device 110.

Referring to FIG. 1C, a third exemplary embodiment of a system implementing advertisement control unit 150 within digital device 110 is shown. Herein, digital device 110 is portable with an integrated display. One example of portable digital device 110 is a mobile telephone that is cellular or wireless enabled.

For this embodiment of the invention, mobile telephone 110 includes a casing 194, a user interface 195 (e.g. touch screen, keypad, etc.), a speaker 196 and a microphone 197. Herein, advertisement control unit 150 may be hardware, firmware and/or software such as a downloadable application that is executed by a processor implemented within casing 194 of mobile telephone 110. For that embodiment of the invention, advertisement control unit 150 either can be (i) prestored within local memory of mobile telephone 110 at manufacturer, (ii) stored prior to distribution to the user, or (iii) downloaded into local memory by the user initiating communications with a remote source such as an application server. These communications may be over a private or public network to an application server hosted by any of the following: the cellular telephone service provider, the telephone manufacturer/distributor, or a third party.

According to one embodiment of the invention, upon being implemented within mobile telephone 110, advertisement control unit 150 operates in the background by monitoring the playback behavior for the user as well as controlling the types of broadcast advertisements downloaded, stored and/or substituted with stored advertisements based on heuristic information of the recipient as described in FIGS. 1A & 1B. As a result, the advertisements played back with audiovisual programs are more tailored to the recipient.

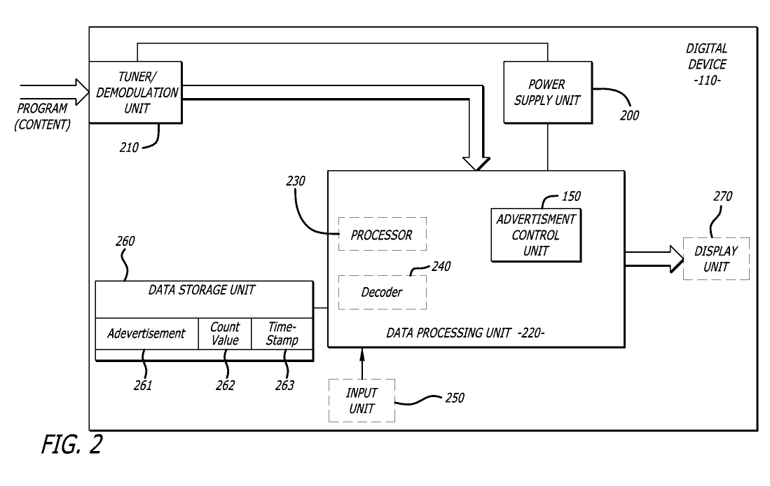

Referring now to FIG. 2, an exemplary diagram of an embodiment of digital device 110 of content delivery system 100 is shown. According to this embodiment of the invention, digital device 110 comprises a power supply unit 200, a tuner/demodulation unit 210 and data processing unit 220. According to this embodiment of the invention, power supply unit 200 is adapted to provide power to tuner/demodulation unit 210 and data processing unit 220. Power supply unit 200 may provide regulated power based on input power received from a wall socket (e.g., 110 volts alternating current “VAC”, 220 VAC, etc.) or may include a battery implemented within digital device 110. Tuner/demodulation unit 210 tunes to one or more channels to receive incoming digital content and demodulates the content to recover the advertisements and the audiovisual program. The audiovisual program and the advertisements are routed as one or more digital bit streams to data processing unit 220.

According to one embodiment of the invention, data processing unit 220 comprises a processor 230 and/or a decoder 240. These components may be implemented as separate integrated circuits or as a single integrated circuit. As described herein, data processing unit 220 features logic operating to decode and process incoming information as well as advertisement control unit 150 that is adapted to assist in controlling advertisement selection, storage and/or playback based on heuristic information. More specifically, heuristic information for one or more recipients corresponding to digital device 110 can be used to (i) notify the content provider of the advertisement profile of the recipient in order to better target the advertisements intended for playback with the audiovisual program to the interests of the recipient, and/or (ii) control the playback of advertisements during viewing of the audiovisual program as described above.

Referring still to FIG. 2, an input unit 250 may be implemented as an integral part of digital device 110 or may be separate and remotely located from digital device 110 (not shown). Similarly, display unit 270 may be implemented as an integral part of digital device 110 or may be separate and remotely located there from (not shown).

In general, according to one embodiment of the invention, advertisement control unit 150 is adapted to generate the advertisement profile based, at least in part, on responses to inquiries within user interfaces during the registration process. Also, advertisement control unit 150 is further adapted to recommend types of broadcast advertisements to be output by the content provider and to substitute broadcast advertisements received with the audiovisual program with advertisements retrieved from a data storage unit 260 as needed. Data storage unit 260 operates as local memory for digital device 110 to store advertisements 261 along with a corresponding count value 262 and time stamp 263. Count value 262 may be adapted to either represent the number of times that the particular advertisement has been displayed or represent the number of times that advertisements for a particular genre of advertisements has been displayed. Time stamp 263 identifies the last time that the advertisement has been displayed. This information enables advertisement control unit 150 to alter the display frequency for that advertisement as needed.

According to one embodiment of the invention, the advertisement playback scheme supported by advertisement control unit 150 utilizes tags within the digital content in order to identify to advertisement control unit 150 what advertisements are to be retrieved from data storage unit 260. Alternatively, as shown for illustrative purposes, the advertisement playback scheme may involve data processing unit 220 accessing metadata within an Adaptation field of one or more Motion Picture Experts Group (MPEG) packets associated with the broadcast and/or stored advertisements.

For broadcast advertisements, the metadata within the Adaptation field allows advertisement control unit 150 to (i) determine whether this advertisement has already been selected in accordance with heuristic information for the recipient; (ii) determine whether the genre or category of the advertisement is authorized by the recipient for playback on display unit 270 (e.g., not subject to parental controls); (iii) determine if the advertisement can be stored within data storage unit 260; and/or (iv) identify the allocated playback time period for the advertisement.

For instance, where the advertisement is selected according to heuristic information, no adjustment of the playback is necessary. However, if the advertisement is not selected at the content provider, the metadata may be used to determine that the corresponding advertisement being received is within an acceptable genre (or class) for the targeted recipient, and where applicable, can be stored within data storage unit 260 for subsequent playback.

II. Exemplary Messaging Formats

As shown in FIG. 3C, when used to control the selection of advertisements transmitted from the content provider, advertisement profile 300 is placed within header 322 or payload 324 of message 320. Message 320 is routed to the content provider.

As shown in FIG. 3D, an exemplary diagram of an Adaptation field 330 of a frame 325 used for transmission of content from the content provider is shown. Adaptation field 330 is a portion of a MPEG packet of a digital data stream, where according to this embodiment, the MPEG packet is associated with an advertisement to be displayed. Adaptation field 330 features control information 335 to indicate two or more of the following: (i) whether an advertisement playback scheme is enabled; (ii) whether the advertisement already has been selected based on heuristic information of the recipient; (iii) the genre (or category) of the advertisement; (iv) whether there are restrictions against altering the broadcast advertisement; (v) whether the broadcast advertisement can be stored; (vi) the allocated playback period for the advertisement, or the like.

More specifically, according to this particular embodiment of the invention, adaptation field 330 comprises control information 335 that includes at least one bit to indicate whether the advertisement playback scheme is enabled. This enables the digital device to operate in two or more modes, where at least one mode is designed to prevent playback alteration of the advertisement through such actions as fast-forwarding, skipping, pausing, or muting.

For instance, when the portion of the control information 335 associated with the advertisement playback scheme includes three bits, the digital device may operate in eight or less operating modes for controlling advertisement alteration as set forth below in Table A. Of course, more bits may be utilized to support a greater number of operating modes.

TABLE A

| MODE | FAST-FORWARDING | SKIP | MUTE | PAUSE |
|---|---|---|---|---|
| 0 | Permitted at all rates > | Permit | Permit | Permit |
| | normal playback rate | | | |
| 1 | Permitted at all rates > | Prohibit | Permit | Permit |
| | normal playback rate | | | |
| 2 | Permitted at all rates > | Permit | Prohibit | Permit |
| | normal playback rate | | | |
| 3 | Permitted at all rates > | Permit | Permit | Prohibit |
| | normal playback rate | | | |
| 4 | Prohibited at rate ≧30 | Prohibit | Prohibit | Prohibit |
| | times normal playback | | | |
| | rate (30X FF) | | | |
| 5 | Prohibited at rates ≧16 | Prohibit | Prohibit | Prohibit |
| | times normal playback | | | |
| | rate (16X & 30X FF) | | | |
| 6 | Prohibited at rates ≧8 | Prohibit | Prohibit | Prohibit |
| | times normal playback | | | |
| | rate (8X, 16X & 30X FF) | | | |
| 7 | Prohibited at rates ≧2 | Prohibit | Prohibit | Prohibit |
| | times normal playback | | | |
| | rate (2X, 8X, 16X &30X FF) | | | |

As set forth in FIG. 3E, control information 335 of Adaptation header 330 comprises a plurality of sub-fields, including but not limited or restricted to one or more of the following: (1) an advertisement transmission control sub-field 350; (2) an advertisement type sub-field 360; (3) an advertisement replacement type sub-field 370; (4) an advertisement playback sub-field 380; and (4) an advertisement expiration sub-field 390.

Advertisement transmission control sub-field 350, when set, identifies that the broadcast advertisement has already been selected based on the advertisement profile of the recipient. Thus, as an option, advertisement control unit 150 may limit processing time on the corresponding content since replacement of the broadcast advertisement is most likely unnecessary.

Advertisement type sub-field 360 identifies the genre (or category) of the advertisement intended for display. This information may be used by advertisement control unit 150 of FIG. 2 to determine if the incoming advertisement pertains to the category of the recipient, and if not, to cause selection of a replacement advertisement, if this feature is supported. Also, this information may be used to determine if the advertisement can be stored locally.

Advertisement replacement type sub-field 370 identifies a type of advertisement replacement scheme that is available for use by the advertisement control unit in response to detection of an alteration in the playback of the advertisement (e.g., pause, mute or accelerated playback such as fast-forwarding or skipping). For instance, in response to a particular action to alter the playback of an advertisement, such as an action to reduce the viewing time of the advertisement (e.g., x30 FF or skip), the advertisement control unit may substitute the broadcast advertisement with a pre-stored advertisement classified as part of a genre selected by the user. Alternatively, the advertisement control unit may cause the digital device to operate in an abbreviated mode in which one or more partial-length advertisements or static images are substituted for the broadcast advertisement(s). An “abbreviated” advertisement has a display time that is normally 2-10 seconds in duration.

Advertisement playback sub-field 380 identifies whether the advertisement playback feature is enabled, where there may be restrictions against altering of a broadcast advertisement (e.g., fast-forwarding, skipping, pausing, muting, etc.), and if so, to what degree are such alterations permitted as shown above in Table A.

Advertisement expiration sub-field 390 is a value that represents the playback period in which the advertisement is permitted to be displayed. This playback time may be a time frame that is selected by the advertiser in accordance with the commercial longevity of the product and/or services identified in the stored advertisement. For instance, an advertisement for a Fourth of July sale may feature a playback time that is set to elapse on July 5^{th} or July 4^{th} at a certain time of day (e.g., 4:00 PM on July 4^{th}). This sub-field 390 is optional for broadcast advertisements that are not permitted to be stored within the data storage unit and used for subsequent display.

For those advertisement that are stored with the digital device for subsequent playback, in response to an action that alters playback of a broadcast advertisement, a stored advertisement is selected and the playback time, which is represented by the value within sub-field 390, is compared with the real-time clock before playback. If the comparison results in a determination that the playback has elapsed, a different stored advertisement within the same genre or another preferred genre is selected and the comparison operation is repeated. Otherwise, the selected stored advertisement is configured for display.

III. Exemplary Registration Process

Referring to FIG. 4A, an exemplary embodiment of a user interface produced by advertisement control unit 150 of digital device 110 of FIG. 2 to commence recipient registration is shown. Herein, a registration image 400 is displayed by digital device 110 in order to allow the recipient to provide personal information. Herein, a recipient can use a remote or keypad associated with digital device 110 in order to enter alphanumeric characters that will provide some or all of the following information concerning attributes of the recipient: (1) name 410; (2) age 415; (3) gender 420; (4) ethnicity 425; and (5) income level 430.

For some of the recipient-based information, pull-down menus may be provided to allow the recipient to select the appropriate entry. For instance, as shown, a pull-down menu 440 may be provided with two entry selections: male “M” and female “F”. Additionally, pull-down menus may be provided for some of the other categories such as age, ethnicity, and income level. The “name” entry however will most likely be input by the recipient via buttons on a remote or those associated with a digital device or an input mechanism integrated on digital device 110 such as a keypad, a touch screen, or the like.

Referring now to FIG. 4B, an exemplary embodiment of a user interface 450 produced by the advertisement control unit of the digital device to program the preferred advertisements for a first recipient is shown. Herein, user interface 450 provides a plurality of parameters for use in selecting preferred advertisements. For instance, as an example, these parameters include, but are not limited or restricted to a genre parameter 460, a source parameter 470 and a parental control parameter 480.

Genre parameter 460 is used to identify particular types of advertisements that the recipient would like to see interspersed between television programming. Source parameter 470 provides information from where the digital device is to retrieve the advertisements. Parental control parameter 480 provides a mechanism to exclude certain types of advertisements from being displayed on the digital device. For instance, the parental controls may be recipient specific to exclude the displaying of a type of advertisement when a particular recipient is watching or may be generally applied to excluding this type of advertisement from being displayed on the digital device.

The heuristic information gathered during the registration process is used to formulate the advertisement profile that may be (i) stored locally within the digital device and accessible to the advertisement control unit, or (ii) uploaded to the content provider in accordance with any messaging scheme.

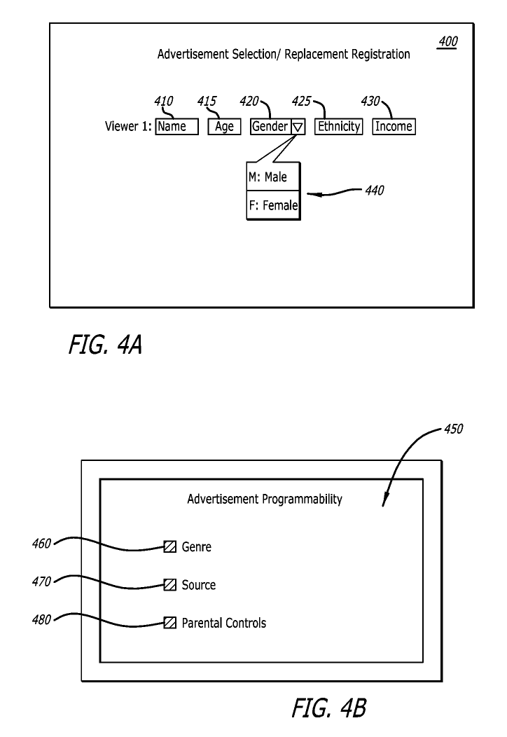

Referring now to FIGS. 5A-5C, exemplary embodiments of selectable user interfaces produced by the advertisement control unit of the digital device in order to program the preferred genre of the advertisements is shown. Herein, FIG. 5A illustrates a first user interface 500 of advertisement genre that is selectable by the recipient. According to this embodiment of the invention, the advertisement genre includes, but is not limited or restricted to financials 502, sports 504, beverages 506, electronics 508, automotive 510, fashion clothing 512, furniture 514, health 516 and other 518. Herein, the recipient selects the genre of advertisements that he or she would be willing to watch in full or in an abbreviated mode in order to (i) customize the advertisement playback for that particular recipient and (ii) assist in creating an advertisement profile for the content recipient.

According to one embodiment of the invention, at least one genre is required to be selected before proceeding to the next user interface of the advertisement selection scheme. Herein, the beverage and automotive categories 506 and 510 are selected by the recipient. In event that the “other” category 518 is selected, another selectable user interface (e.g., screen display) with additional advertisement genres is displayed for the recipient to choose different categories for this particular genre.

Of course, in lieu of selecting the particular genres that are acceptable to the recipient, interface 500 may be adapted so that all of the genre categories are selected. Now, the recipient would need to deselect the particular genre category or categories that he or she does not want to view. Alternatively, the genre categories may be selected automatically according to the identified viewing class of the recipient. For instance, where the recipient is a 16-year old male, electronics and automobiles may be automatically selected as a default with the recipient having the ability to adjust his selections manually.

Referring to FIG. 5B, a second user interface 530 is provided which provides greater granularity as the particular types of automotive advertisements that would be available to the recipient. Herein, according to one embodiment of the invention, the automotive advertisements are categorized according to the make of a particular type of automotive vehicle such as, for example, Lexus® 532, Acura® 534, Ford® 536, BMW® 538, Volvo® 540, Cadillac® 542, Honda® 544, Subaru® 546 and Other 548. According to another embodiment for this user interface, the automotive advertisements may be categorized according to make/model of these automotive vehicles.

In the event that the recipient selects one of the “make” categories illustrated in FIG. 5B, such as the Lexus® category for example, an additional user interface 550 is provided as shown in FIG. 5C. Of course, user interface 550 may be produced automatically or in response to selection of an entry (not shown). As shown, for this embodiment of the invention, user interface 550 is a selectable screen display that allows the recipient to select the particular “model” of the vehicle for which advertisements will be played back for the recipient. For this illustrative example, Lexus® LS460 and Lexus® ES350 sedans are selected.

If none of the vehicle models are selected, all Lexus® models will be selected by default in order to comply with the recipient's request for Lexus® advertisements in user interface 530 of FIG. 5B. Similarly, for the automotive “makes” set forth in FIG. 5B, in the event that none of these are selected by the recipient, the advertisement control unit enters into a default state where all automotive makes are selected in order to comply with the recipient's request for automotive advertisements in user interface 500 of FIG. 5A.

The heuristic information gathered during from the selectable user interfaces may be either (i) stored locally within the digital device and accessible to the advertisement control unit, or (ii) uploaded to the content provider in accordance with any messaging scheme.

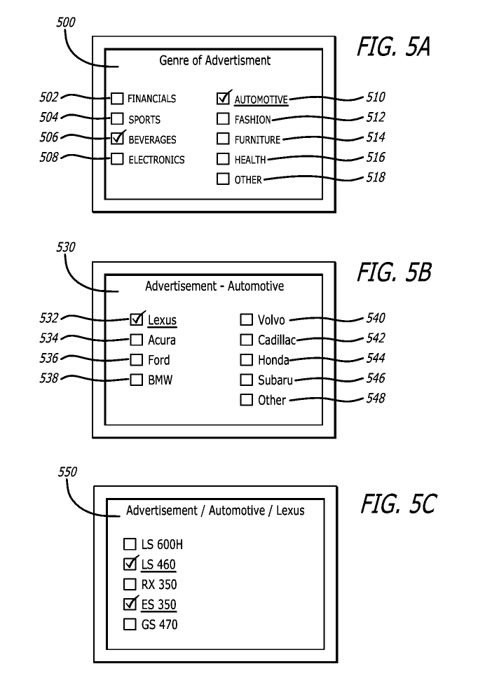

Referring now to FIGS. 6A and 6B, user interfaces 600 and 630 are shown in order to allow the recipient to select the particular source upon which the advertisements may be extracted. As shown in FIG. 6A, user interface 600 displays the sources from which advertisements can be recovered or obtained. These sources may include, but are not limited or restricted to a particular content provider 610 or various websites accessible over the Internet 620. Upon selecting advertisements from the content provider, advertisements periodically may be uploaded to the digital device therefrom and stored in local memory for subsequent retrieval. The periodicity of the uploading may be on a daily basis or with greater periodicity such as on an hourly basis.

Upon selecting the Internet parameter, user interface 630 is generated, which is illustrated as a screen display that lists websites 640 and 645 from which the advertisements may be downloaded. These websites 640 and 645 may be dedicated websites for particular advertisers or websites of particular content providers or broadcasters. Alternatively, the websites may be a video based website from which revenue could be realized by the broadcasters from advertisements extracted from that particular website.

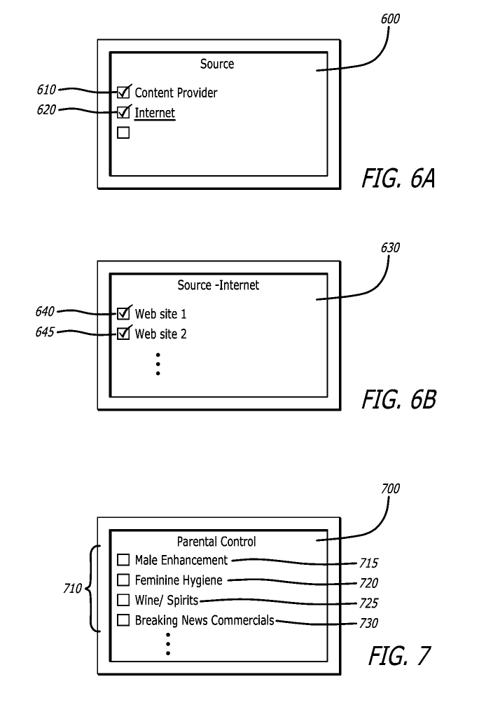

Referring now to FIG. 7, an exemplary embodiment of the parental control user interface 700 is shown. Herein, various adult-oriented genres 710 are listed to enable a guardian of the recipient to select particular genres or advertisement categories that the recipient should not be allowed to view. For instance, such categories may include, for example, male enhancements 715, feminine hygiene products 720, wine & spirits 725, breaking news commercials 730 which are normally geared toward sensationalism, and the like. By selecting any of “parental control” genre, the advertisement control unit prevents such genre from being displayed.

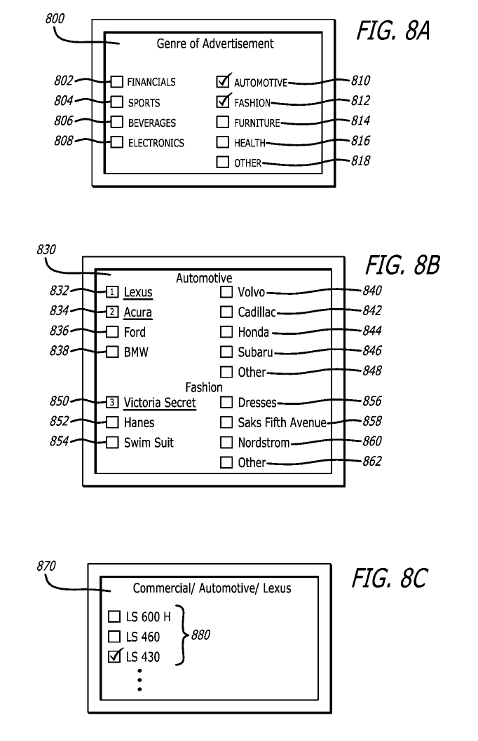

Referring now to FIGS. 8A-8C, exemplary embodiments of selectable user interfaces produced by the advertisement control unit of the digital device in order to program the preferred genre of the advertisements according to a rating scheme is shown. Herein, FIG. 8A illustrates a first user interface 800 of advertisement genre that is selectable by the recipient. According to this embodiment invention, the advertisement genre includes, but is not limited or restricted to financials 802, sports 804, beverages 806, electronics 808, automotive 810, fashion 812, furniture 814, health 816 and other 818. Herein, the recipient selects the genre of advertisements that he or she would be willing to watch in full or abbreviated mode in order to customize the advertisement playback for that particular recipient or the genre is selected based on registration materials and/or monitored behaviors of the recipient.

According to one embodiment of the invention, at least one genre is required to be selected before proceeding to the next segment of the advertisement selection scheme. Herein, the automotive and fashion categories 810 and 812 are selected by the recipient. As previously described, in event that an “other” category 818 is selected, another user interface (e.g., screen display) with additional advertisement genres is displayed for the recipient to select different categories for this particular genre. Alternatively, in lieu of selecting the particular genres that are acceptable to the recipient, user interface 800 may be adapted so that all of the genre categories are selected. Now, the recipient would need to deselect the particular genre category or categories that he or she does not want to view.

Referring to FIG. 8B, a second user interface 830 is provided which provides greater granularity as to the particular types of automotive and fashion advertisements that are acceptable to the recipient. Herein, according to one embodiment of the invention, the automotive advertisements are categorized according to the make of a particular type of automotive vehicle such as, for example, Lexus® 832, Acura® 834, Ford® 836, BMW® 838, Volvo® 840, Cadillac® 842, Honda® 844, Subaru® 846 and Other 848. The fashion advertisements are categorized according to clothing maker, clothing type and/or store such as Victoria Secret® 850, Hanes® 852, swimsuit 854, dresses 856, Saks Fifth Avenue 858, Nordstrom 860, and other 862.

Instead of selecting the categories, the recipient can use the remote or input device to provide preference ratings for each of these categories. For instance, according to this example, Lexus® and Acura® advertisements are rated “1” and “2” by depressing a corresponding numeral on the keypad of the remote while Victoria Secret advertisements was rated “3”. Further granularity of advertisements may be provided as described above, where each category provides sub-categories for the user to select.

As shown in FIG. 8C, for this embodiment of the invention, user interface 870 is a selectable screen display that allows the user to select the particular “model” 880 of the vehicle for which advertisements will be played back for the recipient. If none of the vehicle models are selected, all Lexus® models will be selected by default in order to comply with the recipient's request for Lexus® advertisements in user interface 830 of FIG. 8B.

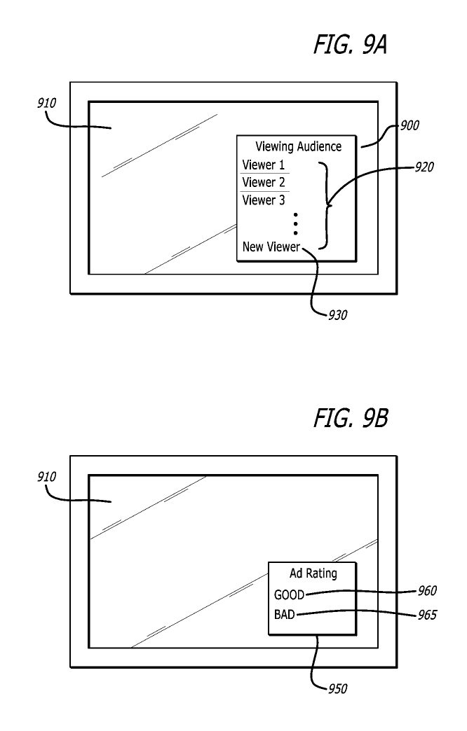

Referring now to FIG. 9A, after a recipient has registered his or her advertisement preferences, the advertisement control unit provides a control panel that identifies which registered recipient is currently watching the program. According to this embodiment of the invention, a control panel 900 is superimposed over an audiovisual program 910 that is being watched. Control panel 900 is used to determine the current audience in order to provide appropriate controls signals to the advertisement control unit for advertisement selection and/or messaging to the content provider to alter the type of advertisements downloaded to the digital device.

Herein, control panel 900 includes one or more selectable entries 920 that are each associated with a registered recipient and designate which of the registered recipients form the audience. An additional entry 930, when selected, begins registration of a new recipient. Upon selection of an entry associated with a registered recipient, the advertisement control unit is provided information that the registered recipient is part of the audience. Hence, the advertisements will be tailored to the audience. Control panel 900 may be displayed at initial power-on of the digital device and may be intermittently displayed automatically or in response to commands initiated by the recipient via the remote or a panel located on the digital device itself.

In the event that the audience is identified as consisting of multiple registered recipients, the advertisement control unit determines if there is a subset of advertisements that are preferred by the entire audience. In the event that the recipients substantially differ in advertisement preferences, and thus no subset can be computed, the advertisement control unit may be adapted to select those advertisements that are preferred by any of the registered recipients. The advertisements may be pseudo-randomly selected or may be selected according to a particular pattern. For instance, the advertisements may be intermixed so that the first advertisement is of a genre preferred by the first recipient while the second advertisement is of a genre preferred by the second recipient, and the like. Alternatively, the advertisements may be weighted.

If parental controls are in place for at least one of the recipients or for the digital device in general, the genre of advertisements that have been disallowed from viewing will not be shown, even if one of the recipients has such advertisements as part of his or her preferences. Besides mere selection of entries by the recipients, passwords may be required where parental controls are in effect.

Control panel 900 may also be used to remove a registered recipient from the audience by deselecting the recipient once he/she is not part of the audience. As an example, this would remove a designation (e.g. underline, highlight, etc.) from the recipient's listed name. As a result, the advertisements may be specifically tailored to the remaining recipient(s).

Of course in lieu of recipient registration, it is contemplated that the registration process could be directed toward a category of recipients such as “adults” and “minors” for instance. In this situation, the recipient can be tailored to a broad category of recipients. Initially, the advertisements are tailored in accordance to the behavior of the recipient.

Referring to FIG. 9B, after a recipient has registered his or her advertisement preferences, the advertisement control unit may also be signaled to provide a control panel 950 that enables one or more registered recipients currently watching the audiovisual program to rate the displayed advertisements. For example, control panel 950 may be initiated for display by the recipient through a command transmitted to the digital device via a remote. A simple commercial review process may simply indicate that the advertisement was good (“1”) 960 or bad (“0”) 965. Of course, a more complex review process may be implemented that enables the recipient to provide a rating 1-10 or 1-100 for the advertisement, where one end of the range indicates a complete lack of viewing enjoyment while another range indicates full enjoyment in viewing the advertisement.

This information may be part of the heuristic information concerning the behavior of the recipient.

IV. Exemplary Advertisement Playback Based on Heuristic Information

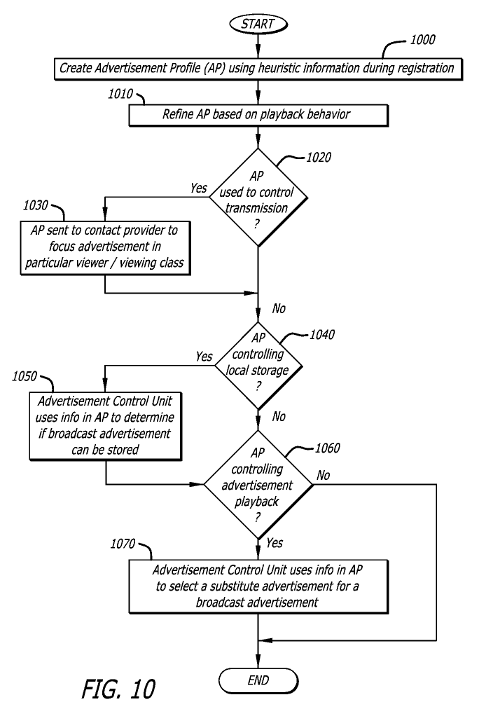

Referring now to FIG. 10, an exemplary embodiment of a flowchart highlighting the control in the playback of advertisements based on heuristic information. First, an advertisement profile is created for a recipient based on heuristic information provided by the recipient during a registration process (item 1000). As an optional feature, the advertisement profile is used to identify the targeted recipient of the advertisement as a member of a particular class. This class influences the type of advertisements that are transmitted to the digital device.

As the advertisement profile is created, additional heuristic information concerning the behavior of the recipient can be used to further refine the advertisement profile (item 1010). It is contemplated that the fast-forward, pause, mute or skip command received during playback of the broadcast advertisement may alter (or refine) the heuristic information concerning the recipient.

As another optional feature, the advertisement profile may be uploaded to the content provider to restrict the types of advertisements downloaded to the digital device. These restricted advertisements would fall within the same “viewing class” as assigned to the targeted recipient (items 1020 and 1030).

Additionally, the playback of the advertisements may be controlled locally (items 1040 and 1050). For instance, upon receipt of the incoming content, a determination is made whether the advertisement playback feature is enabled, and thus, may impose restrictions against the storage of the advertisement during playback. Also, the advertisement control unit determines if the broadcast advertisement falls into a particular genre and/or viewing class upon which storage is permitted.

Finally, the playback of the advertisements may be altered to allow for substitution of stored advertisements for incoming broadcast advertisements (items 1060 and 1070). For instance, upon receipt of the incoming broadcast advertisement, a determination is made whether the advertisement playback feature is enabled that imposes restrictions against the playback of the advertisement. For instance, where the advertisement control unit determines that the broadcast advertisement either is not directed to a particular genre or does not falls with a viewing class of the recipient, the broadcast advertisement is substituted for a locally stored advertisement that is updated over time.

It is contemplated that the selection of the locally stored advertisement may be in accordance with heuristic information such as, for example, the genre with the highest preference ratings (if rating are used) or according to a preferred genre identified by at least one of the recipients. This heuristic information also may include (i) a count value indicating the number of times that the advertisement has been selected which cannot be exceeded, and/or (ii) a time-stamp value indicating the last time the stored advertisement was displayed, and/or (iii) any feedback received from the recipient after prior displays of the advertisement that can be used in the selection process.

Having disclosed exemplary embodiments and the best mode, modifications and variations may be made to the disclosed embodiments while remaining within the spirit of the invention as defined by the following claims.

What is claimed is:

1. Adapted for receiving downloaded digital content, an apparatus comprising:
a data storage unit that stores heuristic information pertaining to a user of the apparatus, the heuristic information including data that identifies attributes of the user; and
a data processing unit coupled to the data storage unit, the data processing unit accessing the heuristic information and transmitting a signal that is used to at least partially control types of broadcast advertisements being downloaded so that the broadcast advertisements are more suited to subject matter of interest to the user.

2. The apparatus of claim 1, wherein the heuristic information includes data that identifies subject matter preferences for the broadcast advertisements by the user.

3. The apparatus of claim 1, wherein the data processing unit to control storage of the broadcast advertisements with the data storage unit based on the heuristic information.

4. The apparatus of claim 3, wherein the data processing unit to permit storage of a first broadcast advertisement of the broadcast advertisements when a viewing class of the first broadcast advertisement matches a viewing class of the user.

5. The apparatus of claim 4, wherein the data processing unit to substitute a second broadcast advertisement of the broadcast advertisements with a stored advertisement within the data storage unit if a viewing class of the second broadcast advertisement differs from a viewing class of the user and a viewing class of the stored advertisement is the same as the viewing class of the user.

6. The apparatus of claim 1, wherein the user is a content recipient being one or more targeted recipients of the downloaded digital content.

7. The apparatus of claim 1, wherein the data processing unit further formulating the heuristic information based at least in part on a behavior of the user of the apparatus during playback.

8. The apparatus of claim 7, wherein the behavior of the user is determined by monitoring wireless commands transmitted to the apparatus and producing the heuristic information based on the monitored wireless commands.

9. The apparatus of claim 1, wherein the signal transmitted from the data processing unit includes the heuristic information or data representative of the heuristic information.

10. The apparatus of claim 9, wherein the data storage unit further storing the downloaded broadcast advertisements that are selected based on heuristic information within the signal.

11. A method for targeting downloaded digital content to a content recipient using heuristic information, the method comprising:
storing heuristic information pertaining to the content recipient, the heuristic information at least one of attributes of the user and advertisement preferences by the user, the heuristic information being adapted to identify advertisement subject matter of interest to the content recipient; and
accessing the heuristic information and producing a signal that is used to at least partially control a type of broadcast advertisement being downloaded so that the broadcast advertisement is more suited to the subject mater of interest to the content recipient.

12. The method of claim 11 further comprising controlling storage of the broadcast advertisement based on the heuristic information.

13. The method claim 12, wherein the controlling storage of the broadcast advertisement includes permitting storage of the broadcast advertisement when a classification of the broadcast advertisement matches a classification of the content recipient.

14. The method of claim 12 further comprising substituting the broadcast advertisements with a stored advertisement if a classification of the broadcast advertisement differs from a classification of the content recipient and a classification of the stored advertisement is the same as the classification of the content recipient.

15. The method of claim 11, wherein prior to storing the heuristic information, the method further comprises formulating the heuristic information based at least in part on a behavior of the content recipient during playback.

16. The method of claim 15, wherein the behavior of the content recipient is determined by monitoring wireless commands and producing the heuristic information based on the monitored wireless commands.

17. The method of claim 11, wherein the producing of the signal includes generating a message including the heuristic information or data representative of the heuristic information.

18. A method for targeting downloaded digital content to a digital device controlled by a content recipient using heuristic information, the method comprising:
computing heuristic information pertaining to the content recipient from monitored wireless commands received by the digital device;
storing the heuristic information pertaining to the content recipient, the heuristic information including at least one of attributes of the user and subject matter of advertisements preferred by the content recipient; and
altering playback of advertisements downloaded as part of the digital content using the heuristic information.

19. The method of claim 18, wherein the altering of the playback of the advertisements includes accessing the heuristic information and producing a signal that is used to at least partially restrict the subject matter of broadcast advertisements being downloaded.

20. The method of claim 18, wherein the altering of the playback of the advertisements comprises:
controlling storage of a broadcast advertisement using the heuristic information; and
subsequently substituting one of the broadcast advertisements with a stored advertisement if the one of the broadcast advertisements differs from a classification of the content recipient that is formulated from the heuristic information.
